(19) United States
(12) Patent Application Publication
(10) Pub. No.: US 2017/0076349 A1
(43) Pub. Date: Mar. 16, 2017

(54) KIOSK-BASED IN-STORE CUSTOM STATIONERY FULFILLMENT SYSTEM

(71) Applicants: Katherine Rohach Miller, Minneapolis, MN (US); Sarah Laurel Hanlon, Edina, MN (US)

(72) Inventors: Katherine Rohach Miller, Minneapolis, MN (US); Sarah Laurel Hanlon, Edina, MN (US)

(21) Appl. No.: 15/266,274

(22) Filed: Sep. 15, 2016

Related U.S. Application Data
(60) Provisional application No. 62/218,673, filed on Sep. 15, 2015.

(51) Int. Cl. G06Q 30/06; G06F 3/0484

(52) U.S. Cl. CPC G06Q 30/0621; G06F 3/04845; G06F 3/04842

(57) ABSTRACT

Embodiments of a system and method for designing and/or ordering customized stationery are generally described herein. A method may include registering a customer, at a kiosk, receiving a selection of a preliminary design, the preliminary design corresponding to a physical sample in a sample book coupled to the kiosk, displaying a user interface, at the kiosk, the user interface including a virtual display of the preliminary design, receiving a custom design modification to the virtual display, modifying the user interface to present a custom design based on the custom design modification, and storing the custom design.

### CLAIM OF PRIORITY

This patent application claims the benefit of priority of U.S. Provisional Patent Application Ser. No. 62/218,673, titled “Kiosk-Based In-Store Custom Stationary Fulfillment System,” filed on Sep. 15, 2015, which is hereby incorporated by reference herein in its entirety.

### BACKGROUND

Social stationery, such as wedding invitations, baby announcements, holiday cards, graduation announcements, personal stationary, social invitations, and the like are well known. Typically, consumers have the options of purchasing more generic social stationery from a large retailer, purchasing semi-custom stationery through online retailers, or customizing stationery designed by and purchased from boutique social stationery stores. Buying social stationery from large retailers may include the drawback of lacking an interactive and personalized customer experience with knowledgeable customer-service support. Buying social stationery online includes the drawbacks of an inability for the customer to touch and feel the final product (e.g., card stock, raised letters, etc.) before the product is purchased and delivered as well as offering fewer customizable choices than a boutique. This often results in an undesired finished product. Buying from a boutique social stationery store may be highly personalized and interactive, but may be cost-prohibitive and time-consuming for some customers, or may be difficult to access based on geographical constraints.

Boutiques, online retailers, and large retailers currently work directly with internal or external printing houses. These options, however, lack a way for a consumer to place a designed custom order with an external printing house without an intermediary.

### SUMMARY

In various embodiments, methods and systems for kiosk-based in-store custom stationery fulfillment are presented.

There remains a need for an economical social stationery ordering system that customers can access in a retail store, with an interactive, personal zed experience and access to physical samples. There also remains a need for an economical sales option for retail stores looking to provide personalized stationary offerings without having to invest heavily in staffing, training and expensive inventory and sample books generally present at a boutique store. The presently described systems and methods provide a solution that meets this need.

According to an embodiment, a method may include registering a customer, at a kiosk, receiving a selection of a preliminary design, the preliminary design corresponding to a physical sample in a sample book coupled to the kiosk, displaying a user interface, at the kiosk, the user interface including a virtual display of the preliminary design, receiving a custom design modification to the virtual display, modifying the user interface to present a custom design based on the custom design modification, and storing the custom design.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a perspective view of an in-store personalized design studio in accordance with some embodiments of the present description.

FIG. 2 illustrates generally a user interface for customizing social stationery in accordance with some embodiments of the present description.

FIG. 3 illustrates generally a schematic of a system for customizing social stationery in accordance with some embodiments of the present description.

FIG. 4 illustrates generally a flowchart showing a technique for customizing social stationery in accordance with some embodiments of the present description.

FIG. 5 illustrates generally an example of a block diagram of a machine upon which any one or more of the techniques discussed herein may perform in accordance with some embodiments of the present description.

### DETAILED DESCRIPTION

Custom stationery is an important part of formal events, life announcements, and other invitations. Often customers must compromise between getting the custom stationery of their dreams and keeping down costs, While customers may save money by using corporate stationery, more desirable custom options under this approach are highly limited. At the other end of the custom spectrum, boutique designers may give customers beautiful custom stationery, but at a high cost. The present inventors have recognized that an in-store personalized design studio allows a customer to achieve a high degree of customization while still keeping costs down.

The in-store personalized design studio allows for an individualized, boutique experience for creating custom stationery. The custom stationery station may include a designer-less kiosk with designer-quality stationery. The custom stationery may include wedding invitations, shower invitations, baby announcements, graduation party invitations, or the like. A physical book may be present at the custom stationery station of the personalized design studio to allow a customer to touch and feel physical samples and get an idea of what the custom stationery may look and feel like in a physical format.

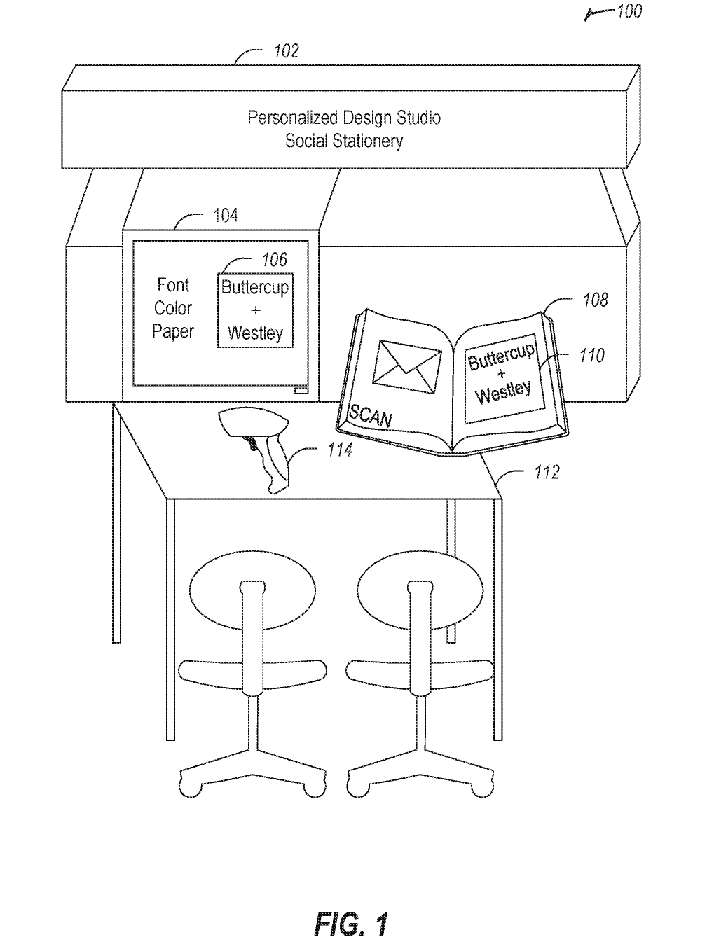

FIG. 1 illustrates generally an in-store personalized design studio 100 in accordance with some embodiments. The personalized design studio 100 includes a branding area 102 that may have unique branding. For example, the personalized design studio 100 may include a store-within-a-store featuring branding in branding area 102 that is designed to feature a style congruent with or different than the branding of the host store. Additionally, the branding area 102 may include private label branding or allow, e.g., guest branding. Further, the seating and structure of the personalized design studio 100 may be designed to look congruent with or different than the host store. The personalized design studio 100 may include a physical location within a store, including seating (e.g., for two people) and branding (either to fit in with the retailer branding, or to stand out from the retailer). In another example, the branding area 102 may include branding similar to the host store for an integrated feel. The personalized design studio 100 may be in an aisle of the host store, similar to a small boutique. In yet another example, the personalized design studio 100 may be a standing kiosk. The seated kiosk option may present a more boutique feel and provide greater comfort to the customer, which may result in a better customer experience. In an example, a customer must first register at the personalized design studio 100 in a store before accessing a custom design at a mobile device or computer. For example, the requirement that a customer must first register at the personalized design studio 100 may incentivize a store (e.g. a retail store), to host the personalized design studio 100. In another example, a customer may register on an app or website, but may be required to visit the personalized design studio 100 in order to complete a transaction (e.g., the customer may not be able to send social stationery to a printer to be printed without physically accessing the personalized design studio 100, registration may not be completed until a customer physically accesses the personalized design studio 100, or payment may be required at the personalized design studio 100). In an example, payment may be received at the personalized design studio 100, via a mobile device, via a computer or tablet, via a third party printer (e.g., a stationery printer), or the like.

As noted, personalized design studio 100 may be placed in a store, e.g., a retail store. Alternatively, personalized design studio 100 may be placed at a school (e.g., a high school or university) for purposes of designing and/or ordering related social stationery (e.g., graduation announcements, and the like), or any other appropriate venue in which it may be desirable to design and purchase social stationery (e.g., a special event such as a wedding expo, baby expo, special event expo, etc.

The personalized design studio 100 includes a display 104, such as a computer screen, monitor, television, touchscreen, or the like. The personalized design studio 100 also may include a physical sample book 108. The display 104 may include a user interface for displaying a design selection. The personalized design studio 100 may include the display 104 and a processor coupled to a memory device, the memory device containing instructions that, when executed by the processor, cause the processor to perform operations comprising: receiving a selection of a preliminary design, the preliminary design corresponding to a physical sample 110 in the sample book 108, presenting, on a user interface of the display 104, a virtual design 106 of the preliminary design, receiving a custom design modification to the virtual design, modifying the user interface to present a custom design based on the custom design modification, and storing the custom design. The physical sample 110 in the sample book 108 may correspond to the virtual design 106, which may be modified by a customer, including editing font, color, paper, and other characteristics of the custom stationery, as shown on a user interface on the display 104.

The display 104, the physical sample book 108, or other displays or printed material may show explanations for typical bridal design and social stationery questions or explanations for print types such as letterpress and others, or paper types, fonts, colors, or the like. For example, the display 104 or sample book 108 may include frequently asked questions with respect to a number topics related to social stationery, including the physical aspects of the social stationery (e.g., letterpress, paper types, fonts, color, or the like), trends, printing methods, or the like. Additionally or alternative)y, the display 104 or sample book 108 may include explanations for frequently asked questions related to the etiquette associated with sending social stationery, such as wedding invitations. Where the display 104 is used to provide such explanations, the display may provide an interactive link to a professional dedicated to answering questions related to such topics.

The sample book 108 may include a sample set, ink samples, paper samples, physical samples, custom design samples, or the like. The sample book 108 may include scannable text, a barcode, identifying mark, or the like that may be scanned by a scanner 114, or a mobile device, or may include a number, name, or text that may be entered into a computer or mobile device to identify the physical sample 110 to create the virtual design 106 on the display 104. For example, a customer may scan text in the sample book 108 using the scanner 114. In another example, a customer may enter the name of the physical sample 110 listed in sample book 108 at the personalized design studio 100, on an app on a mobile device, or on a website to create the virtual design 106 to start the custom stationery design process. The scanner may be coupled to other components of the personalized design studio 100, such as to a computer controlling the display 104. The information scanned by the scanner 114 may be automatically sent to a social media site or an email address. Other design or customization information may be sent to a social media site or email address, such as after the custom design phase, after the custom design is sent to a printer, etc.

A customer may customize the virtual design 106 on the display 104, on a mobile device app, or on a website. After the design customization is complete, the customer may choose to send the custom design to a printer. The customer may choose this option on the in-store display 104, an app on a mobile device, or on a website, The printer to whom the custom design will be sent may include a stationery printer. The stationery printer may be a third party printer or otherwise remote to the personalized design studio 100. The stationery printer may be in a different physical location than the kiosk.

In an example, the personalized design studio 100 may include a printer (e.g., a local printer) for printing a proof of a custom design. Printing a proof may include instant proofing, which may include an on-screen option on the display 104 for proofing, an option to print a proof at the personalized design studio 100 for visual inspection, sending the proof via email, or sending the proof to an app for printing at home, etc.

The personalized design studio 100 may include an input device, such as a keyboard, for receiving customer identifying information at the kiosk. Once received, the customer identifying information may be incorporated and integrated into the virtual design 106 on the display 104 for a more personalized experience.

In another example, the display 104 may present an option to upgrade the custom experience of the personalized design studio 100 by offering options to take the custom design to a local boutique for further customization, such as at a reduced price. The local boutique may be selected from a list of local boutiques based on the physical location of the personalized design studio 100, from a map, from a database of preferred suppliers, etc.

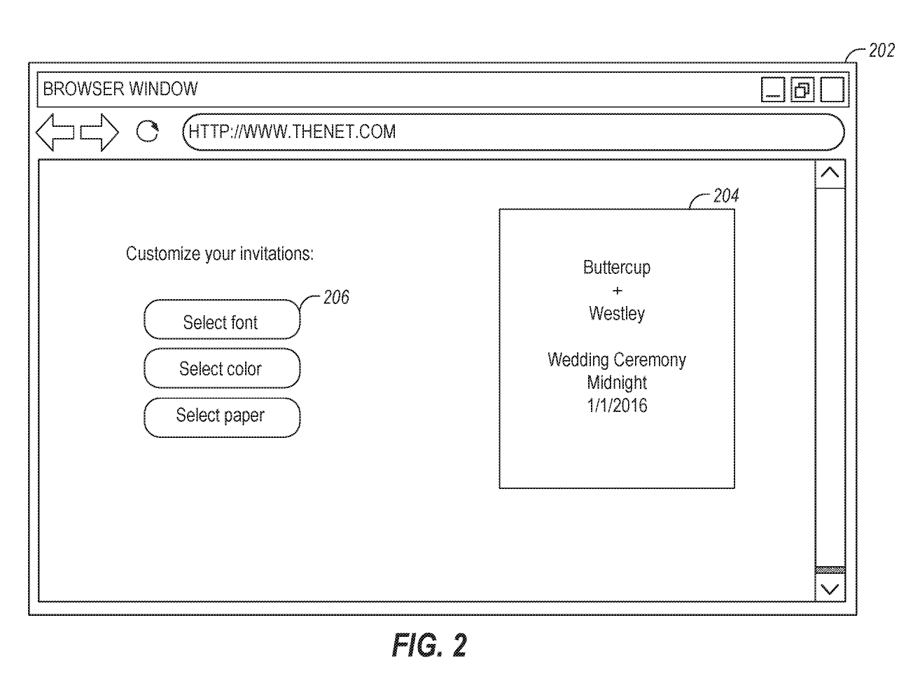

FIG. 2 illustrates generally a user interface 202 for customizing social stationery in accordance with some embodiments of the present description. The user interface 202 includes a custom design 204 and customization options 206. The user interface 202 is an interactive user interface that guides a customer through a customization process, and may mimic an experience with a design specialist. The user interface 202 may include a display of trends, etiquette, styles, printing methods, letterpress, personalized information, specific recommendations (e.g., calendar, timeline, to do list), or the like. In an example, the user interface 202 includes a consumer experience beyond the custom design of social stationery, such as lifestyle options, updates (e.g., your wedding is in 6 months!), or recommendations for other purchases (e.g., information about bridal supplies, baby registry, holiday merchandise, or new home needs available in the host store), which may additionally be printed at the personalized design studio.

In an example, the user interface 202 includes an option to input the name of the bride and groom, as well as other optional information such as the wedding date, parents names, wedding venue, or the like. The user interface 202 may auto-populate fields the custom design 204 with the relevant information to personalize the custom experience. In another example, the user interface 202 may include preselected options, such as color or favorite font, etc., and display those options in the custom design 204.

The user interface 202 may include a browser window as shown in FIG. 2, for display on a computer, tablet, mobile device, etc. In another example, the user interface may include an app for a mobile device or tablet. In yet another example, the user interface 202 may include a stand-alone application running at a kiosk, such as an immersive application presented on a display of a kiosk.

In an example, a design created at a kiosk may be saved for later access, such as at the kiosk, on a mobile device, on a computer, on a tablet, etc. The design may be saved locally at the kiosk or in a database (e.g., on the cloud). The design may be saved to a user account (e.g., a bride account, a wedding account, a baby account, etc.) or an email address. A transaction using the design may be completed after the design is saved (e.g., at a later time). For example, a bride and her mom may create one or two options sitting at a kiosk, and then the options may be saved. The options may then later be approved or paid for from home, for example with the groom.

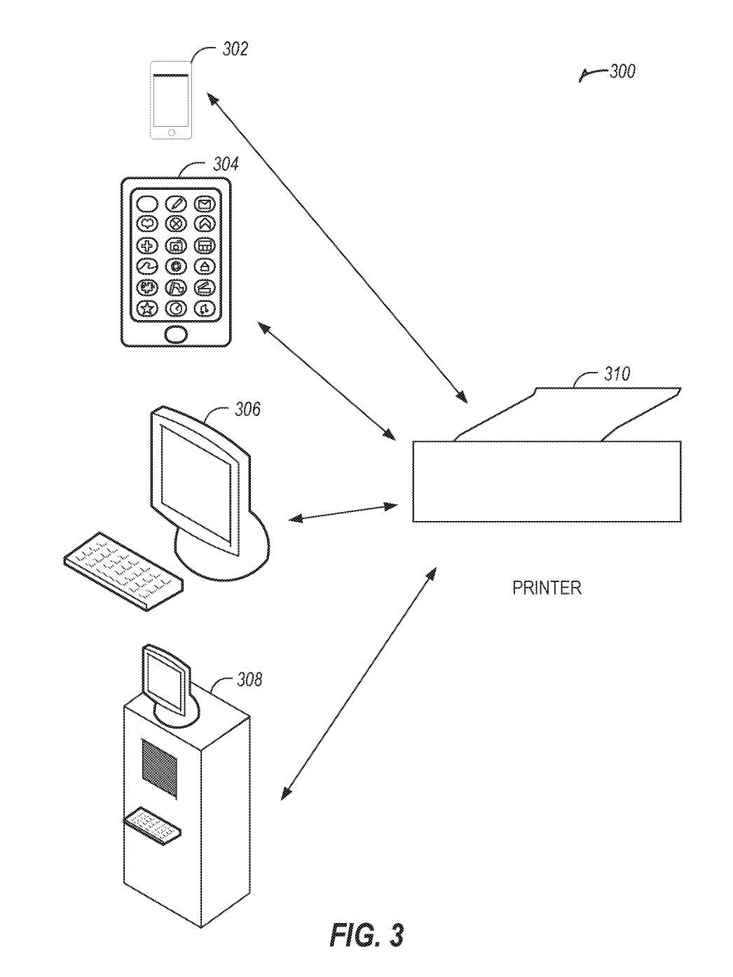

FIG. 3 illustrates generally a schematic of a system 300 for customizing social stationery in accordance with some embodiments. The system 300 may include devices for inputting, displaying, and customizing stationery, such as a mobile device 302, tablet 304, computing device 306, or kiosk 308. The system 300 may include a printer 310 for printing customized stationery and/or proofs for printing approval. The system 300 may include a server for communicating with all the devices. Any of the devices 302, 304, 306, and 308 may be used to select a preliminary design, input information, display a design, modify a design, and schedule printing of a design.

In an example, printer 310 may include an off-site printer, such as a printer remote from the kiosk 308, which may be in a retail store. The printer 310 may include a direct fulfillment printer. Alternatively or additionally, the printer 310 may include a third party printer (e.g., a third party not directly affiliated with the customer, retailer, or kiosk company). The printer 310 may include a device for receiving an order and compiling a custom design to be printed.

In another example, the printer 310 may be selected based on a list, design type, or location of the kiosk. In yet another example, the printer 310 may be selected based on an address a customer inputs. The specific locality of the printer 310 may be selected automatically, or may be selected by a customer.

A customer may upload or indicate a location of a guest list (e.g., by uploading a spreadsheet, indicating a link to a list or database, etc.) including addresses of guests on the guest list. The printer 310 may automatically add addresses to envelopes, stuff the envelopes with custom designed invitations and mail out the custom designed invitations based on the addresses.

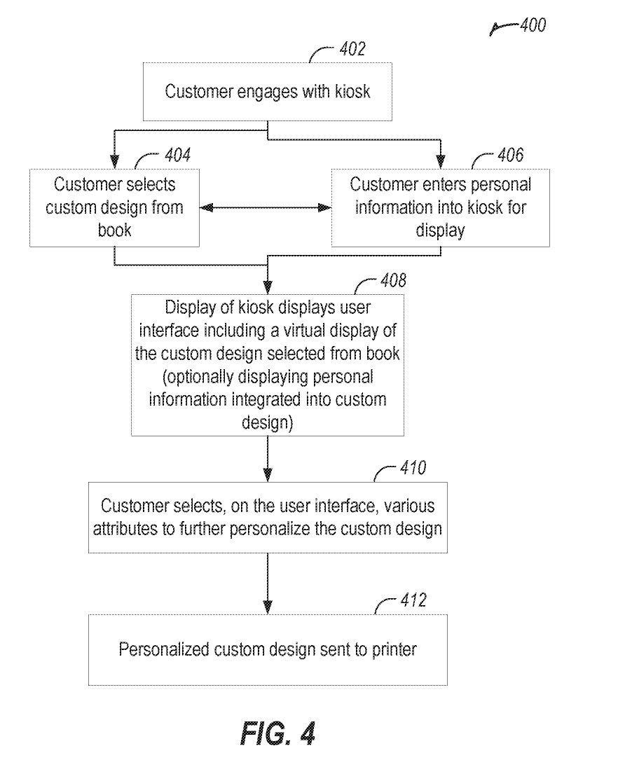

FIG. 4 illustrates generally a flowchart showing a technique 400 for customizing social stationery in accordance with some embodiments of the present description. The technique 400 includes an operation 402 to receive an indication of a customer engaging with a kiosk, such as by receiving registration information for a customer. In an example, a customer must first register at the kiosk in a store.

The technique 400 includes an operation 404 to receive a selection of a custom design from a sample book, such as a sample book coupled to the kiosk. The technique 400 includes an operation 406 to receive personal information of the customer, input at the kiosk or a mobile device, for display. Operations 404 and 406 may be done in any order, or operation 406 may be omitted. Operation 404 may include receiving the selection from a scanner at the kiosk, from a scan at a mobile device, or from an input device at the kiosk.

The technique 400 includes an operation 408 to display, at the kiosk, a user interface including a virtual display of the custom design selected from the sample book. Operation 408 may include displaying the personal information of the customer and integrating the personal information of the customer into the virtual display of the custom design.

The technique 400 includes an operation 410 to receive a selection, on the user interface, of various attributes to further personalize the custom design. In another example, operation 410 may be omitted. In an example, instead of, or in addition to, operation 410, personalization or customization of the design may be received from a mobile device via an app, from a computer via a website, or from the kiosk, via an application.

The technique 400 includes an operation 412 to send the personalized custom design to a printer. Operation 412 may be omitted. In an example, instead of or in addition to, operation 412, the personalized custom design may be stored, such as locally at the kiosk, in the cloud, or the like. The printer of operation 412 may include a stationery printer, such as a stationery printer in a different physical location than the kiosk.

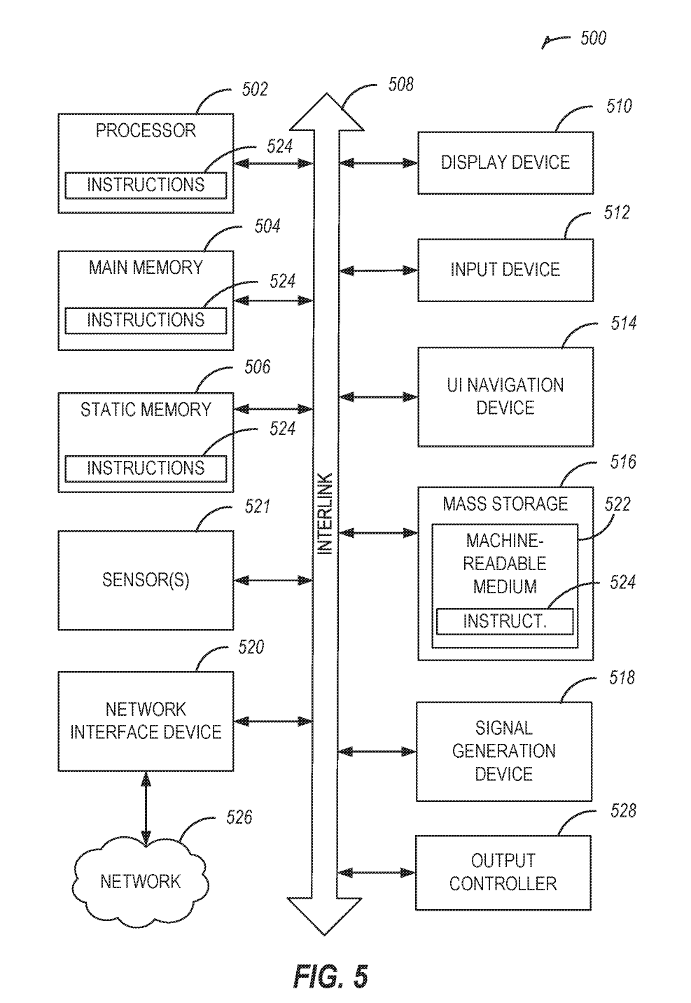

FIG. 5 illustrates generally an example of a block diagram of a machine 500 upon which any one or more of the techniques discussed herein may perform in accordance with some embodiments. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in a peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions sequential or otherwise that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions, Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, interact protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### VARIOUS NOTES & EXAMPLES

Each of these non-limiting examples may stand on its own, or may be combined in various permutations or combinations with one or more of the other examples.

Example 1 includes the subject matte embodied by a method for designing customized stationery, the method comprising registering a customer, at a kiosk, receiving a selection of a preliminary design, the preliminary design corresponding to a physical sample in a sample book coupled to the kiosk, displaying a user interface including a virtual display of the preliminary design, receiving a custom design modification to the virtual display, modifying the user interface to present a custom design based on the custom design modification, and storing the custom design.

In Example 2, the subject matter of Example 1 may optionally include sending the custom design to a printer.

In Example 3, the subject matter of one or any combination of Examples 1-2 may optionally include sending the custom design to a stationery printer.

In Example 4, the subject matter of one or any combination of Examples 1-3 may optionally include wherein the stationery printer is in a different physical location than the kiosk.

In Example 5, the subject matter of one or any combination of Examples 1-4 may optionally include receiving customer identifying information at the kiosk.

In Example 6, the subject matter of one or any combination of Examples 1-5 may optionally include wherein modifying the user interface to present the custom design includes integrating customer identifying information into the custom design.

In Example 7, the subject matter of one or any combination of Examples 1-6 may optionally include wherein receiving the selection of the preliminary design includes receiving the selection from a scanner at the kiosk.

In Example 8, the subject matter of one or any combination of Examples 1-7 may optionally include wherein receiving the selection of the preliminary design includes receiving the selection from a mobile device.

In Example 9, the subject matter of one or any combination of Examples 1-8 may optionally include receiving a second custom design modification to the custom design.

In Example 10, the subject matter of one or any combination of Examples 1-9 may optionally include wherein receiving the second custom design modification includes receiving the second custom design modification at the kiosk from a remote mobile device or remote computing device.

Example 11 includes the subject matter embodied by a system comprising a sample book, and a kiosk coupled to the sample book, the kiosk including a display and a processor coupled to a memory device, the memory device containing instructions that, when executed by the processor, cause the processor to perform operations comprising: receiving a selection of a preliminary design, the preliminary design corresponding to a physical sample in the sample book; presenting, on a user interface of the display, a virtual design of the preliminary design; receiving a custom design modification to the virtual design; modifying the user interface to present a custom design based on the custom design modification; and storing the custom design.

In Example 12, the subject matter of Example 11 may optionally include operations comprising sending the custom design to a printer.

In Example 13, the subject matter of one or any combination of Examples 11-12 may optionally include operations comprising sending the custom design to a stationery printer.

In Example 14, the subject matter of one or any combination of Examples 11-13 may optionally include wherein the stationery printer is in a different physical location than the kiosk.

In Example 15, the subject matte of one or any combination of Examples 11-14 may optionally include operations comprising receiving customer identifying information at the kiosk.

In Example 16, the subject matter of one or any combination of Examples 11-15 may optionally include wherein the operations comprising modifying the user interface to present the custom design include operations comprising integrating customer identifying information into the custom design.

In Example 17, the subject matter of one or any combination of Examples 11-16 may optionally include wherein the operations comprising receiving the selection of the preliminary design include operations comprising receiving the selection from a scanner coupled to the kiosk.

In Example 18, the subject matter of one or any combination of Examples 11-17 may optionally include wherein operations comprising receiving the selection of the preliminary design include operations comprising receiving the selection from a mobile device.

in Example 19, the subject matter of one or any combination of Examples 11-18 may optionally include operations comprising receiving a second custom design modification to the custom design.

In Example 20, the subject matter of one or any combination of Examples 11-19 may optionally include wherein the operations comprising receiving the second custom design modification include operations comprising receiving the second custom design modification at the kiosk from a remote mobile device or remote computing device.

Example 21 includes at least one machine-readable medium including instructions for receiving information, which when executed by a machine, cause the machine to perform any of the methods of Examples 1-10.

Example 22 includes an apparatus comprising means for performing any of the methods of Examples 1-10.

The above detailed description includes references to the accompanying drawings, which form a part of the detailed description. The drawings show, by way of illustration, specific embodiments in which the invention can be practiced. These embodiments are also referred to herein as “examples,” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. The above description is intended to be illustrative, and not restrictive.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for designing customized stationery, the method comprising:
registering a customer, at a kiosk;
receiving a selection of a preliminary design, the preliminary design corresponding to a physical sample in a sample book coupled to the kiosk;
displaying a user interface including a virtual display of the preliminary design;
receiving, via the user interface, a custom design modification to the virtual display;
modifying the user interface to present a custom design based on the custom design modification; and
storing the custom design.

2. The method of claim 1, further comprising sending the custom design to a printer coupled to the kiosk.

3. The method of claim 1, further comprising sending the custom design to a stationery printer.

4. The method of claim 3, wherein the stationery printer is in a different physical location than the kiosk.

5. The method of claim 1, further comprising receiving customer identifying information at the kiosk.

6. The method of claim 5, wherein modifying the user interface to present the custom design includes integrating the customer identifying information into the custom design.

7. The method of claim 1, wherein receiving the selection of the preliminary design includes receiving the selection from a scanner coupled to the kiosk.

8. The method of claim 1, wherein receiving the selection of the preliminary design includes receiving the selection from a mobile device.

9. The method of claim 1, further comprising receiving a second custom design modification to the custom design.

10. The method of claim 9, wherein receiving the second custom design modification includes receiving the second custom design modification at the kiosk from a remote mobile device or remote computing device.

11. A system comprising:
a sample book; and
a kiosk coupled to the sample book, the kiosk including:
a display; and
a processor coupled to a memory device, the memory device containing instructions that, when executed by the processor, cause the processor to perform operations to:
receive a selection of a preliminary design, the preliminary design corresponding to a physical sample in the sample book;
present, on a user interface of the display, a virtual design of a preliminary design;
receive a custom design modification to the virtual design;
modify the user interface to present a custom design based on the custom design modification; and
store the custom design.

12. The system of claim 11, wherein kiosk further includes a printer, and the processor is further to send the custom design to the printer.

13. The system of claim 11, wherein the processor is further to send the custom design to a stationery printer.

14. The system of claim 13, wherein the stationery printer is in a different physical location than the kiosk.

15. The system of claim 11, wherein the processor is further to receive customer identifying information at the kiosk.

16. The system of claim 15, wherein to modify the user interface to present the custom design, the processor is further to integrate the customer identifying information into the custom design.

17. The system of claim 11, wherein the kiosk further includes a scanner, and wherein to receive the selection of the preliminary design, the processor is to receive the selection from the scanner.

18. The system of claim 11, wherein to receive the selection of the preliminary design, the processor is further to receive the selection from a mobile device.

19. The system of claim 11, wherein the processor is further to receive a second custom design modification to the custom design.

20. The system of claim 19, wherein to receive the second custom design modification, the processor is to receive the second custom design modification at the kiosk from a remote mobile device or remote computing device.
